(19) United States
(12) Patent Application Publication
(10) Pub. No.: US 2009/0099483 A1
(43) Pub. Date: Apr. 16, 2009

(54) APPARATUS AND METHOD FOR ULTRASOUND TREATMENT

(76) Inventor: Andrey Rybyanets, Yoqneam (IL)

Correspondence Address: EMPK & Shiloh, LLP;c/o Landon IP, Inc., 1700 Diagonal Road, Suite 450, Alexandria, VA, 22314, US

(21) Appl. No.: 11/870,445

(22) Filed: Oct. 11, 2007

(51) Int. Cl. A61H 1/00

(52) U.S. Cl. 601/2

(57) ABSTRACT

A transducer for generating an intensity pattern of ultrasound comprising: a plurality of elements independently excitable to radiate acoustic energy; and a controller that simultaneously excites some of the elements while leaving at least one element dormant and changes which element is dormant to change the intensity pattern.

### FIELD

The invention relates to methods and apparatus for performing acoustic procedures on tissue.

### BACKGROUND

Various methods are known for delivering and coupling acoustic energy to a region of tissue to perform a diagnostic and/or therapeutic and/or cosmetic procedure on a patient's tissue. Among such procedures are for example, non-invasive assaying of blood analytes, drug delivery by phonophoresis, lithotripsy, tissue ablation and lysis of fat cells for cosmetic removal of adipose tissue.

For many types of therapeutic and/or cosmetic acoustic applications, such as for example lithotripsy, tissue ablation and lysis noted above, sufficient acoustic energy must be delivered to a tissue region to destroy and remove tissue in the region. Generally, the acoustic energy is delivered by focusing at least one beam of relatively intense ultrasound on the region. The high intensity, focused ultrasound, conventionally referred to by the acronym “HIFU”, may be used to generate various thermal and mechanical effects on tissue that include local heating of tissue and/or cavitation that disrupts and destroys the tissue. Tissue raised to and maintained at a temperature above about 42° C. rapidly dies and mechanical stresses generated by cavitation breach and tear cell membranes of the tissue.

Various studies have indicated that efficacy of destruction and removal of tissue from a tissue region using high intensity ultrasound can generally be enhanced by applying more than one frequency of ultrasound to the region. Typically, the ultrasound is applied to the region by generating two beams of different frequency ultrasound using separate transducers and driving circuits and focusing the beams on the region.

P. Z. He et al in “Dual-Frequency High Intensity Focused Ultrasound (HIFU) Accelerating Therapy”; Proceedings of the IEEE Engineering in Medicine and Biology, 27th Annual Conference, Shanghai, China; Sep. 1-4, 2005; pp 213-216, concluded from “preliminary experimental results” that “dual frequency HIFU induces larger lesion in tissue than conventional single frequency HIFU under the same exposure conditions”. The dual frequency experiments were carried out by irradiating tissue regions, apparently simultaneously, with ultrasound at 1.563 MHz and 1.573 MHz radiated by central disc and confocal annulus PZT-4 transducers, respectively. G. lernetti et al in “Enhancement of high-frequency cavitation effects by a low frequency stimulation”, Ultrasonics Sonochemistry 4 (1997) pp 263-268, describe enhancing cavitation effects in tissue generated by relatively high frequency ultrasound at 700 kHz using relatively low frequency ultrasound at 20 kHz. The low frequency ultrasound was used to generate a “stimulating field” that was applied to a tissue region to amplify cavitation effects of the high frequency ultrasound at different stages of cavitation in the tissue region caused by the high frequency ultrasound.

However, it is often difficult to control high energy focused ultrasound to satisfy constraints that may be required to perform various procedures for which it is intended. For example, HIFU beams are often focused to a relatively small volume of tissue and can require a relatively large dwell time at the focal volume to destroy tissue therein. Treating an extended region of tissue with HIFU can therefore often be a relatively tedious task that requires a relatively long time to perform. As a result, various techniques have been proposed and/or used for expanding a useful focal volume of HIFU beams and for electronically and/or mechanically scanning the beams to treat relatively large tissue volumes. However, control of HIFU beams to deliver effective acoustic energy that is spatially relatively homogenous over an extended tissue volume can be problematic. Often configurations of extended focal volume HIFU beams exhibit “hot spots” that limit therapeutic and/or cosmetic use of the beams.

F. L. Lizzi et al in an article entitled “Asymmetric Focussed Arrays for Ultrasonic Tumor Therapy” describe using “spherical cap transducers with segmented rectangular electrodes” to provide HIFU beams useable to produce lesions with elliptical cross-sections. By phasing excitation of pairs of rectangular electrodes, undesired axial regions of high acoustic intensity of the beams in planes other than a focal plane of the transducers were suppressed. To treat extended tissue regions, the beams are intended for scanning along a direction substantially perpendicular to the long axes of the elliptical lesions.

US Patent Application Publication US 2005/0154314 to J. U. Quistgaard, entitled “Component Ultrasound Transducer” promulgates objects of the invention of the application as: “to provide a transducer capable of transmitting high intensity ultrasound energy into two or more focal zones simultaneously” and also “to provide for a transducer capable of focusing two or more different frequencies into a single focal zone, or into a group of focal zones.”

An embodiment of the invention is described as “a transducer assembly comprising a first focused ultrasound transducer operating at a high frequency for causing bubble formation in adipose tissue and a second transducer operating at a low frequency for collapsing the bubbles formed by the first transducer.

“In a second embodiment of the present invention “there is a transducer assembly having a first focused ultrasound transducer operating at a first frequency and a second transducer operation at a second frequency. During use, the first transducer emits focused ultrasound energy and produces cavitation within a focal region. Micro bubbles form in the adipose tissue in response to the first transducer, and the frequency of ultrasound generated. The second transducer operates at a lower frequency and is broadcast into the patient's tissue either in focused manner or unfocused . . . The frequency of the second transducer is designed to cause the collapse of the bubbles produced by the first transducer.”

“In one alternative embodiment, a plurality of small transducers operating at different frequencies can be focused to a common focal point. The affect of the overlapping frequencies produces the desired cavitation through a beat frequency effect. Thus a first transducer may have a first frequency X₁, while a second transducer has a second frequency X₂. The combination of the two frequencies at the common focal point generates cavitation, and eliminates the danger of heat accumulation and burning on the surface of the patient.”

In an article entitled “Concentric-Ring and sector-Vortex Phased-Array Applicators for Ultrasound Hyperthermia” by C. A Cain and S. I. Umemura, concentric ring and radial sector elements of a transducer are excited with various phase configurations to produce concentric circularly symmetric focal rings of acoustic energy for which acoustic energy at a focus along a central axis is “greatly reduced”. Phasing that generates circularly asymmetric elliptic focal regions is also described.

U.S. Pat. No. 6,506,171 S. Vitek and N Breimer describe a focused ultrasound system that “includes a plurality of transducer elements disposed about and having an angular position with a central axis”. The various sector elements are excited with phases so that “a first on-axis focal zone and a second off-axis focal zone are created”. The figures in the application show that the second off-axis focal zone is characterized by a plurality of focal regions in each of which acoustic energy focused to the region has a substantially same spatial energy distribution. The plurality of focal regions exhibit an almost perfect rotational rosette like symmetry.

All the above referenced documents are incorporated herein by reference.

### SUMMARY OF THE INVENTION

An aspect of some embodiments of the invention relates to providing relatively simple methods and apparatus to generate a pattern of acoustic intensity, which exhibits substantial bilateral asymmetry. In an embodiment of the invention, a bilaterally asymmetric intensity pattern resembles a pinwheel and comprises curved regions of focused acoustic energy.

An aspect of some embodiments of the invention relates to providing focused acoustic energy that provides time dependent patterns of acoustic energy optionally in a focal plane, that progresses in time through a series of configurations, for which some of the configurations exhibit substantial spatial irregularity and are substantially bilaterally asymmetric and some of the configurations are substantially bilaterally symmetric. In an embodiment of the invention, the time dependence is substantially cyclical.

An aspect of some embodiments of the invention, relates to providing acoustic intensity patterns that are rotatable selectively clockwise or counterclockwise.

The inventor has determined that patterns of acoustic energy in accordance with embodiments of the invention provide relatively improved spatial homogenization of acoustic energy deposition in a tissue region. The inventor has further determined that, spatial form and time dependence of the acoustic energy patterns may be configured to generate advantageous stress patterns that optionally include in addition to compressive and tensile stress patterns, stress patterns that provide shear and torsional stress. For example, the inventor has determined that an acoustic field characterized by many different regions that exhibit relatively large gradients tends to generate shear stress in tissue in the regions.

An aspect of some embodiments of the invention relates to providing relatively simple methods of providing time dependent patterns of acoustic energy that exhibit substantial spatial irregularity and bilateral asymmetry.

The inventor has noted that a plurality of transducers having a common focal region may be excited to provide a spatial pattern of acoustic intensity in the focal region having advantageous spatial irregularity and time dependence by exciting each transducer with a driving signal having a different frequency chosen from a group of relatively close frequencies. In some embodiments of the invention, the frequencies are in a range of frequencies from about 200 kHz to about 1 Mhz. Optionally, the frequencies are sufficiently close so that a beat frequency between any two of the frequencies in the group of frequencies is less than or equal to about 15% of the lowest frequency in the group of frequencies. Optionally, the frequencies are sufficiently close so that a beat frequency between any two of the frequencies is less than or equal to about 10% of the lowest frequency in the group of frequencies. Optionally, the frequencies are sufficiently close so that a beat frequency between any two of the frequencies in the group of frequencies is a frequency less than or equal to about 1% of the lowest frequency in the group of frequencies. The inventor has found that, generally, advantageous beat frequencies are in a range from about 300 Hz to about 20 kHz.

There is therefore provided in accordance with an embodiment of the invention, a transducer for generating an intensity pattern of ultrasound comprising: a plurality of elements independently excitable to radiate acoustic energy; and a controller that simultaneously excites some of the elements while leaving at least one element dormant and changes which element is dormant to change the intensity pattern. Optionally, the configuration of elements is rotationally symmetric. Additionally or alternatively, the location of at least one dormant element is optionally rotated selectively clockwise or counterclockwise as a function of time.

In some embodiments of the invention, the at least one dormant element comprises a single element. In some embodiments of the invention, the at least one dormant element comprises a group of adjacent elements. In some embodiments of the invention, some of the elements comprise at least two groups of elements, each group comprising a plurality of adjacent elements.

In some embodiments of the invention, the controller excites at least two elements with AC voltages at different frequencies. Optionally, the controller excites the elements with bursts of AC voltage. Alternatively or additionally, the frequencies are relatively close. Optionally, a beat frequency between any two of the frequencies is less than or equal to about 15% of a lowest frequency of the frequencies. Optionally, a beat frequency between any two of the frequencies is less than or equal to about 10% of a lowest frequency of the frequencies. Optionally, a beat frequency between any two of the frequencies is less than or equal to about 1% of a lowest frequency of the frequencies. Optionally, a beat frequency between any two of the frequencies is in a range between about 300 Hz and about 20 kHz.

In some embodiments of the invention, the controller excites at least two different elements with a same frequency AC voltage having different phases. In some embodiments of the invention, the controller rotates the location of the at least one dormant element clockwise or counterclockwise as a function of time. In some embodiments of the invention, the intensity pattern exhibits a shape of a pinwheel having a plurality of arms. Optionally, the pinwheel pattern is missing an arm.

In some embodiments of the invention, the transducer has a shape of a spherical cap. Optionally, the elements are sectors of the cap having a shape of a spherical triangle. Optionally, the elements are sectors of the cap having a crescent shape.

There is further provided in accordance with an embodiment of the invention, a transducer for generating an intensity pattern of ultrasound comprising: a plurality of elements independently excitable to radiate acoustic energy; and a controller that simultaneously excites at least three different elements at different frequencies wherein a beat frequency between any two of the frequencies is in a range between about 300 Hz and about 20 kHz.

There is further provided in accordance with an embodiment of the invention, a transducer for generating an intensity pattern of ultrasound comprising a plurality of crescent shaped elements independently excitable to radiate acoustic energy.

### BRIEF DESCRIPTION OF FIGURES

Non-limiting examples of embodiments of the invention are described below with reference to figures attached hereto that are listed following this paragraph. Identical structures, elements or parts that appear in more than one figure are generally labeled with a same numeral in all the figures in which they appear. Dimensions of components and features shown in the figures are chosen for convenience and clarity of presentation and are not necessarily shown to scale.

FIGS. 1A-1D schematically illustrate time dependence of an intensity pattern of focused ultrasound that exhibits substantial irregularity and asymmetry, in accordance with an embodiment of the invention;

FIGS. 2A-2D schematically illustrate time dependence of a rotating intensity pattern of focused ultrasound generated, in accordance with an embodiment of the invention;

FIG. 3 schematically shows a cap transducer comprising a plurality of crescent sector piezoelectric elements operable to produce rotatable acoustic intensity patterns, in accordance with an embodiment of the invention.

FIGS. 4A-4H schematically illustrate different excitation patterns of the cap transducer shown in FIG. 3 to generate a rotating pinwheel pattern of acoustic intensity, in accordance with an embodiment of the invention; and

FIGS. 5A-5D schematically illustrate time dependence of a pattern of ultrasound that exhibits substantial spatial irregularity and asymmetry generated by exciting elements of a transducer with AC voltages of different frequencies, in accordance with an embodiment of the invention.

### DETAILED DESCRIPTION

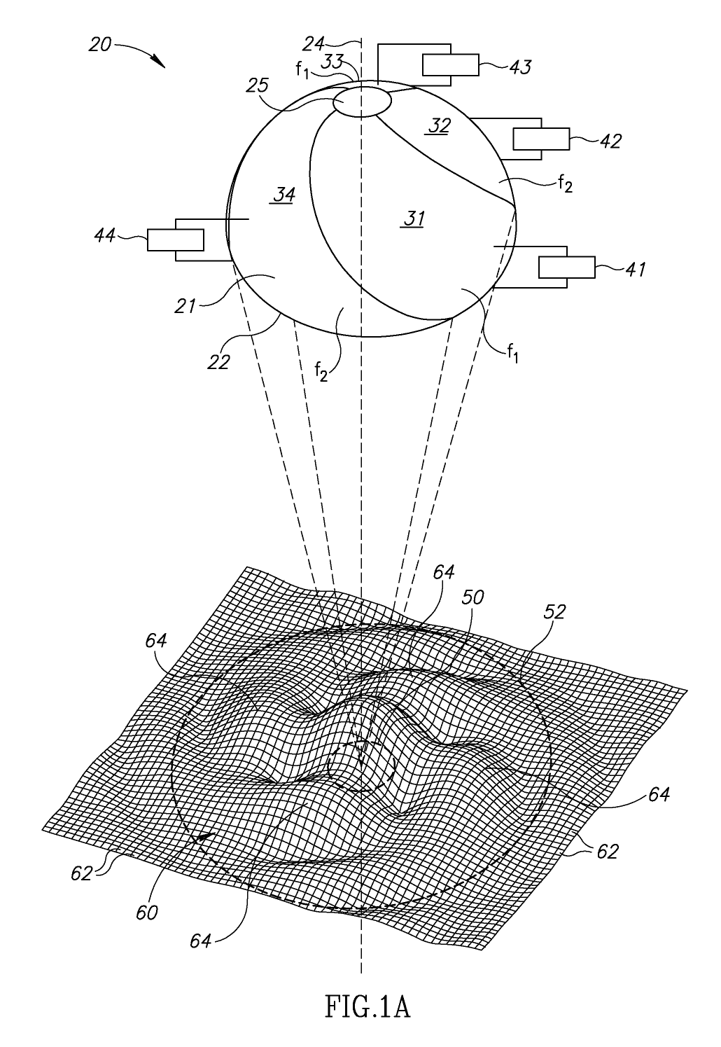

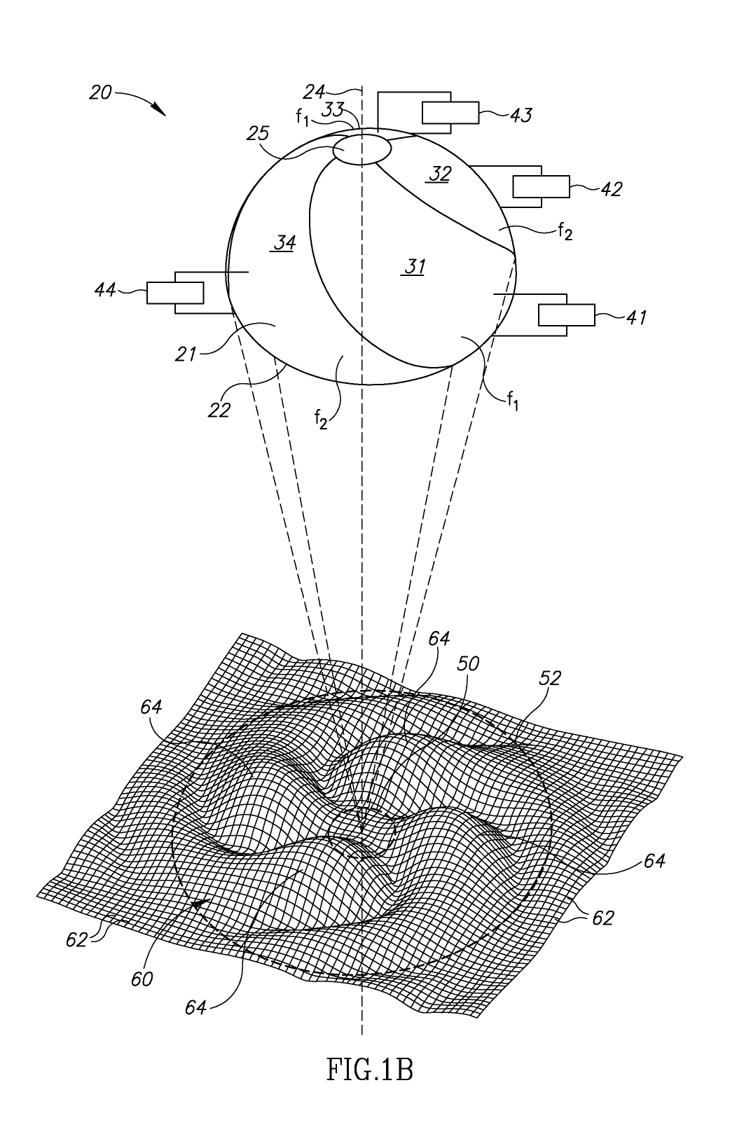

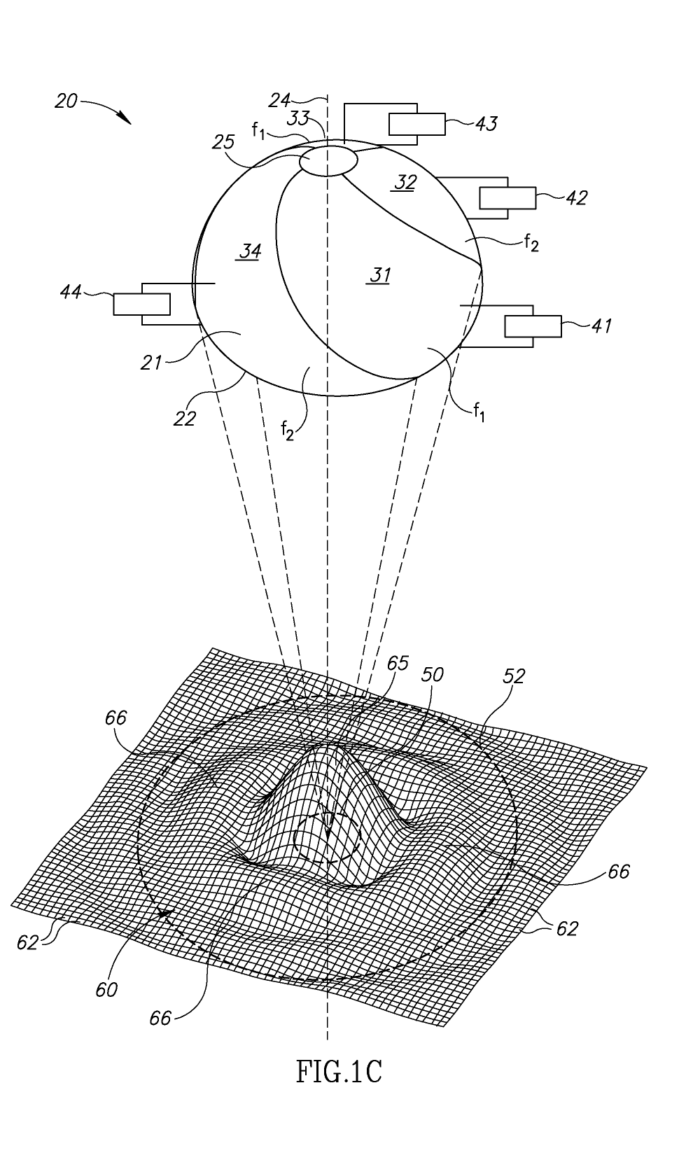

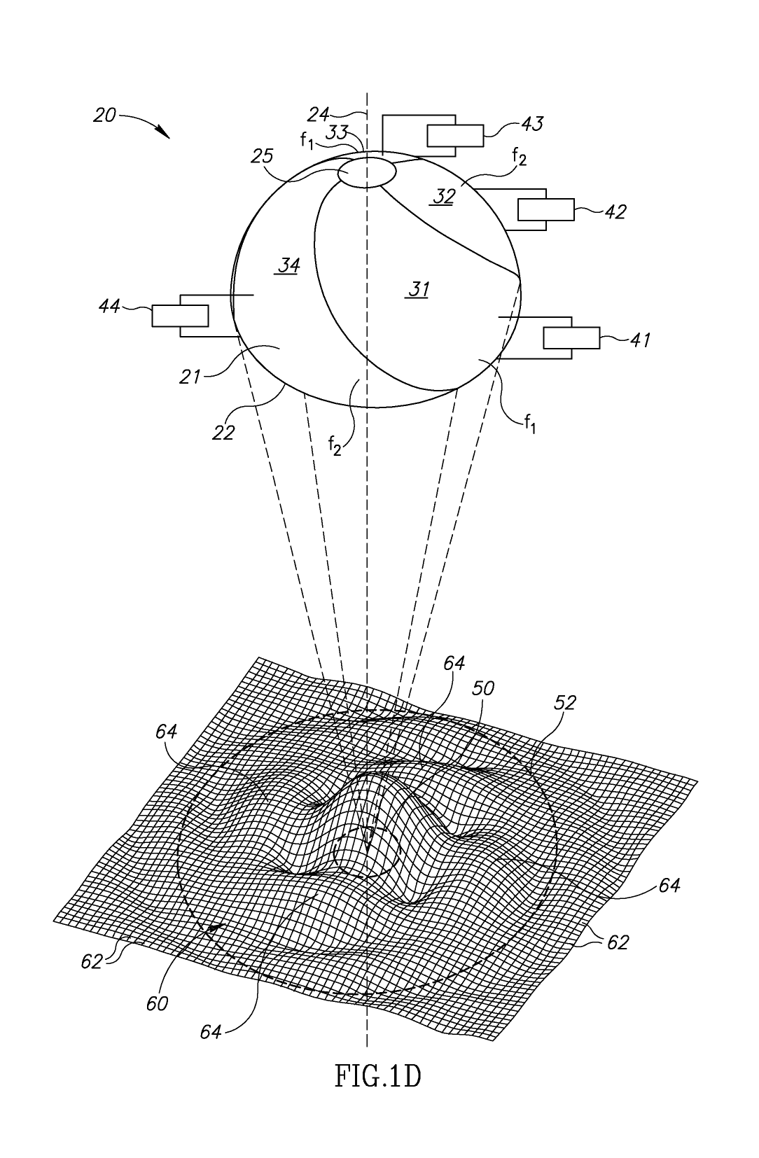

FIGS. 1A-1D schematically show perspective views of a multielement spherical cap transducer 20 having convex and concave sides 21 and 22 and comprising a plurality of, optionally, four crescent shaped sector piezoelectric elements 31, 32, 33, 34, in accordance with an embodiment of the invention. Each crescent sector element 31-34, has a first electrode (not shown) substantially covering a top surface of the sector on convex side 21 of cap transducer 20 and a second electrode substantially covering concave side 22 of the cap transducer. Crescent sector elements 31, 32, 33 and 34 are optionally connected to power supplies 41, 42, 43 and 44 respectively that are controllable to excite the crescent sector elements to radiate acoustic energy. Cap transducer 20 has an axis 24 and is formed having a hole 25 centered on the axis for convenience of production and to provide a convenient location for a sensor, optionally an acoustic sensor, for monitoring an acoustic field generated by the cap transducer.

In accordance with an embodiment of the invention, power supplies 41 and 43 are controlled to excite crescent piezoelectric elements 31 and 33 respectively with AC voltage at a same frequency f₁ and to generate acoustic waves that are focused to a focal volume (not shown) having a cross section indicated by a dashed circle 50 perpendicular to axis 24. Cross section 50 is referred to as a “central focal zone” of cap transducer 20, and the plane of the cross section is referred to as a focal plane of the transducer. Power supplies 42 and 44 are optionally controlled to excite crescent sector elements 32 and 34 with AC voltage f₂ to generate acoustic waves that are also “focused” to central focal zone 50. Focusing of acoustic waves generated by sector piezoelectric elements 31-34 to central focal zone 50 is schematically indicated by dashed lines 36.

In accordance with an embodiment of the invention, frequencies f₁ and f₂ are such that a beat frequency between the frequencies is a frequency that is less than or about equal to 15% of the lower of frequencies f₁ and f₂. Optionally, frequencies f₁ and f₂ are such that a beat frequency between the frequencies is a frequency that is less than or about equal to 10% of the lower of frequencies f₁ and f₂. Optionally, frequencies f₁ and f₂ are such that a beat frequency between the frequencies is a frequency that is less than or about equal to 1% of the lower of frequencies f₁ and f₂. Optionally the beat frequency is between about 300 Hz and about 20 kHz.

In some embodiments of the invention, the AC voltages at frequency f₁ that are applied to excite crescent piezoelectric elements 31 and 33 are in phase. In some embodiments of the invention, the AC voltages at frequency f₂ that are applied to excite crescent piezoelectric elements 32 and 34 are in phase. In some embodiments of the invention, the relative phase of crescent transducers excited with a same frequency excitation is allowed to change. Optionally the relative phase changes randomly.

It is noted that not all the acoustic energy generated by crescent sector elements 31-34 is constrained within central focal zone 50. Acoustic energy provided by the crescent sectors elements generally exhibits substantial intensity in a “penumbra” focal zone that extends from focal zone 50 and is indicated by a dashed circle 52 in the focal plane of central focal zone 50.

Intensity of acoustic energy in focal zone 50 and penumbra focal zone 52 is schematically indicated by an intensity pattern 60 comprising “shape” lines 62. At a given location in the focal plane (i.e. the plane of circles representing focal zone 50 and penumbra focal zone 52) height of displacement of shape lines 62 from the focal plane indicates intensity of acoustic energy at the given location.

In FIGS. 1A-1D and figures that follow, for convenience of presentation, the sizes of focal zone 50 and penumbra focal zone 52 are greatly exaggerated relative to the size of cap transducer 20. For example, whereas a cap transducer may typically be characterized by a radius of curvature of about 50 mm and an aperture of about 85 mm, penumbra focal zone 52 may have a radius of about 6 mm.

Because frequencies f₁ and f₂ are not equal, the relative phases of acoustic waves at frequencies f₁ and f₂ in focal zones 50 and 52 is constantly changing. As a result, assuming continuous excitation of crescent sector elements 31-34, constructive interference of the waves and thereby intensity pattern 60 continuously and cyclically change with a repetition frequency equal to about a beat frequency |f₁-f₂|. FIGS. 1A-1D schematically show computer simulation snapshot images of intensity pattern 60 at corresponding sequential times during a repetition cycle of the intensity pattern. The patterns were generated for frequencies f₁=200 kHz and f₂=220 kHz and excitation voltage of crescent transducers excited with a same frequency excitation in phase. Repetition cycle of intensity pattern 60 was about 50×10⁻⁶ sec. A time during the repetition cycle corresponding to each snapshot image is given in microseconds on the image. Cap transducer 20 was assumed to have a radius of curvature equal to 54 mm and an aperture equal to 85 mm.

Intensity pattern 60 is characterized for most of its repetition cycle by the crescent shape of crescent sector elements 31-34 and generally has a bilaterally asymmetric “pinwheel” shape reflecting the number and curvature of the crescent sectors during most of its repetition cycle. The pinwheel shape is evident in FIGS. 1A, 1C and 1D, and comprises a pinwheel arm 64 for each crescent sector element 31-34. The bilateral asymmetry of the pinwheel shape is expressed by the lack of a plane, for example, a plane through axis 24, for which when exhibiting the pinwheel shape, the parts of intensity pattern 60 on opposite sides of the plane are substantially mirror images of each other. During a portion of the repetition cycle, intensity pattern 60 exhibits a substantially symmetric central peak 65 surrounded by a concentric ring 66. The central peak and concentric ring are shown in FIG. 1B.

It is noted that in the discussion above, FIGS. 1A-1D are assumed to be snapshots of a continuously changing pattern generated by continuous excitation of crescent elements 31-34. It is, of course, possible to generate a sequence of intensity patterns in focal zones 50 and 52 similar to those shown in FIGS. 1A-1D by exciting crescent sectors 31-34 with a sequence of appropriately phased bursts of AC voltage. Optionally, the AC voltages in the bursts applied to different sectors have a same frequency or relatively close frequencies such as the frequencies f₁ and f₂ used to generate the images shown in FIGS. 1A-1D. Optionally, the bursts have duration at least equal to about a period of a beat frequency of the AC voltages applied to crescent elements 31-34.

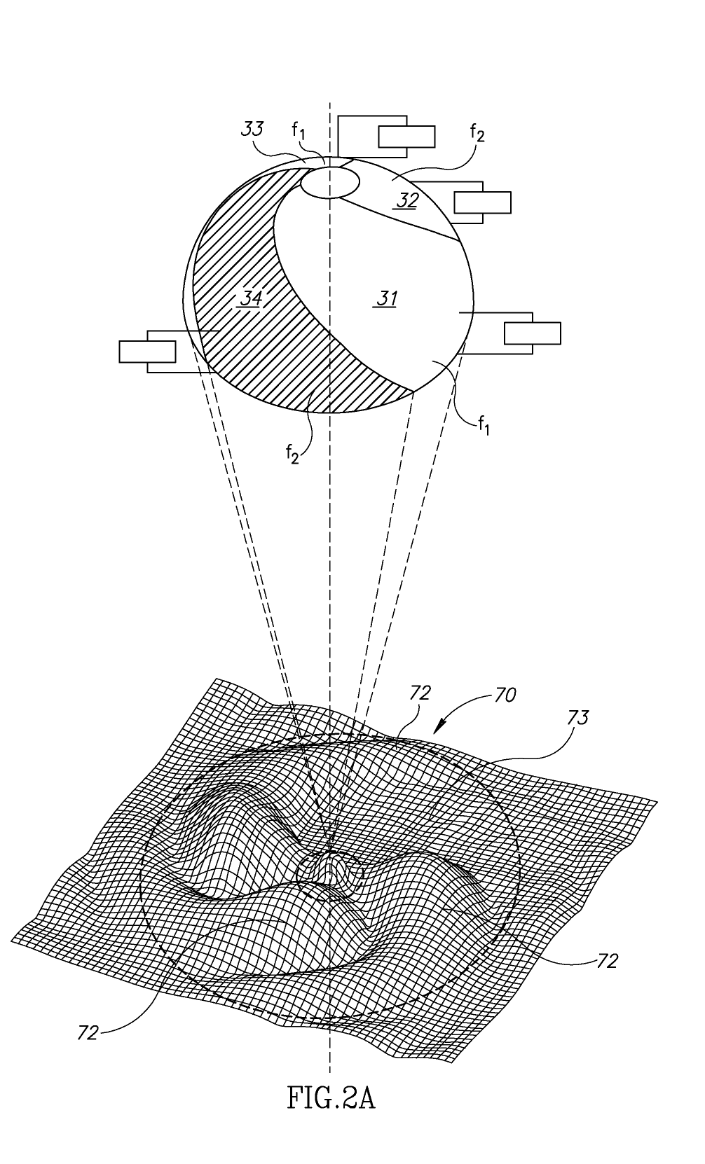

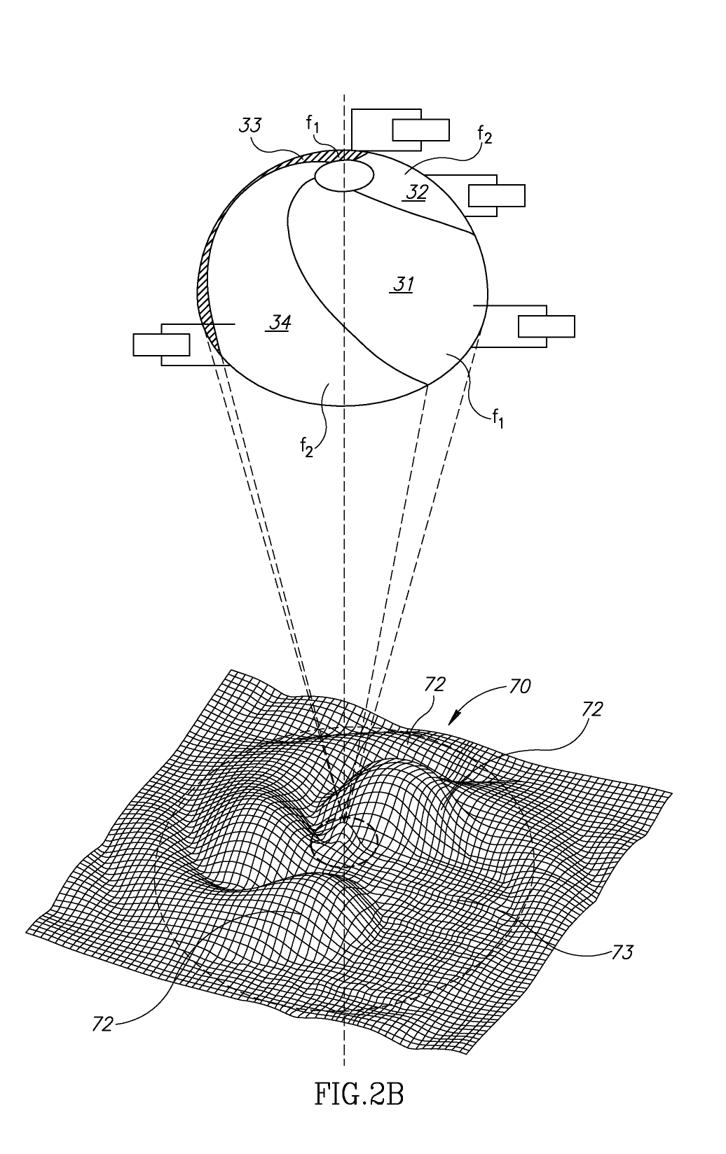

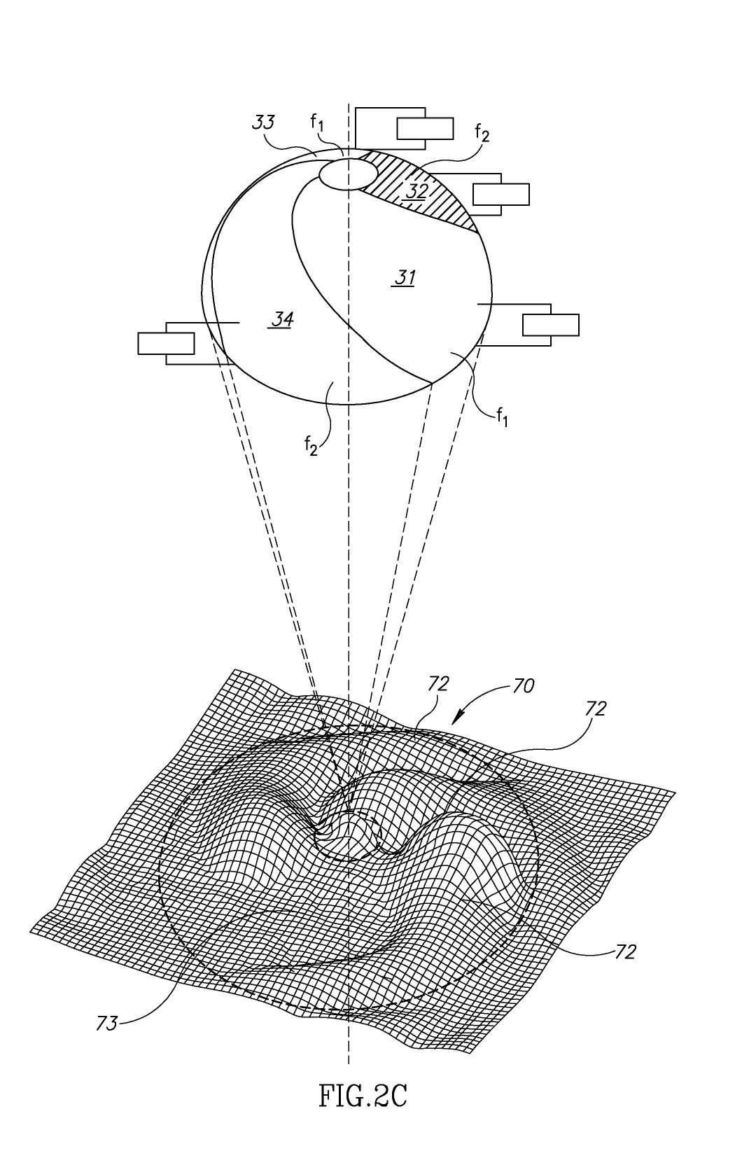

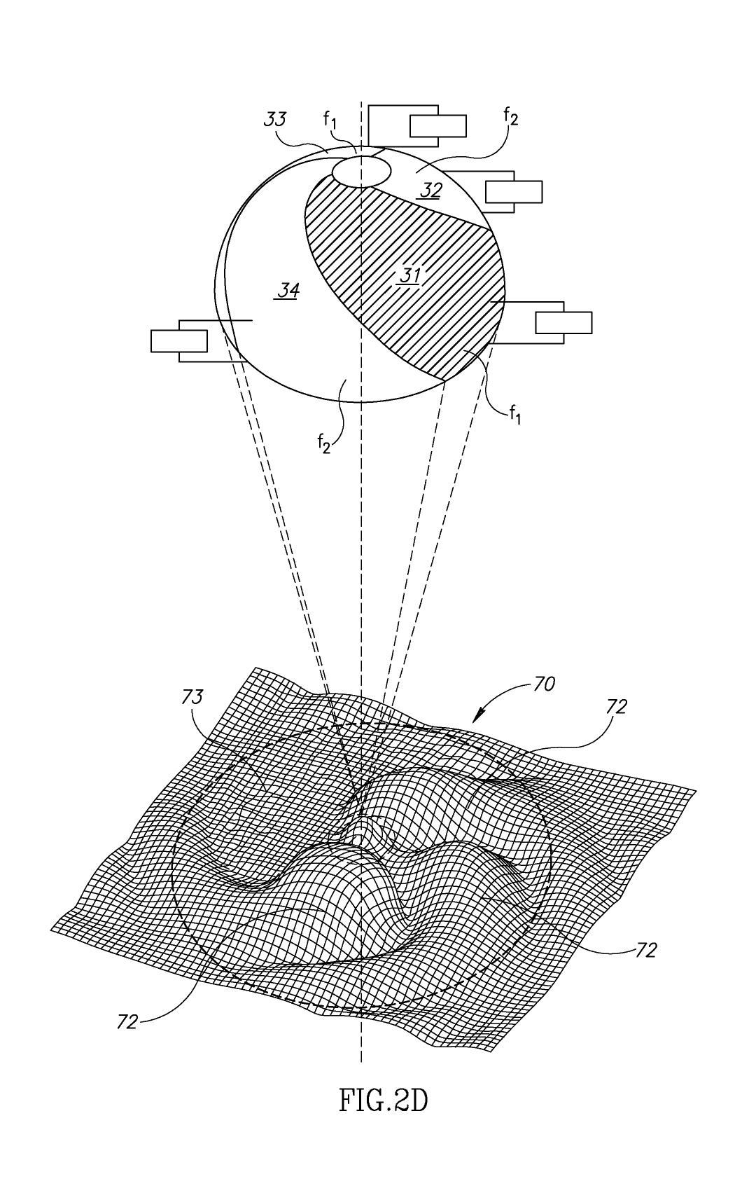

In some embodiments of the invention, crescent sectors 31-34 are excited, optionally by a suitable power supply or configuration of power supplies such as power supplies 41-44, to generate a rotating intensity pattern having a pinwheel configuration similar to that shown in FIGS. 1A, 1B and 1D but missing one of arms 64. FIGS. 2A-2D schematically show a time sequence of computer simulated snapshot images of an optionally clockwise rotating, “missing arm” pinwheel intensity pattern 70 having three arms 72 corresponding to arms 64 of pattern 60 shown in FIG. 1B and a nodal region 73 of relatively low or substantially zero intensity replacing the fourth arm 64 of pattern 60. In the sequence of images, pinwheel intensity pattern 70 rotates clockwise about axis 24 of cap transducer 20, e.g. in FIG. 2B arms 72 are rotated clockwise with respect to the arms in FIG. 2A.

In accordance with an embodiment of the invention, intensity pattern 70 is generated by repeatedly, substantially simultaneously exciting different configurations of three of four crescent sectors 31-34 with bursts of AC voltage but leaving a fourth, “dormant”, sector unexcited. In accordance with an embodiment of the invention, each time three of sectors 31-34 are excited, adjacent excited sectors are excited with AC voltage at a same frequency but relative phase of 90°. The dormant crescent sector is rotated clockwise from one set of simultaneous excitations to a next set of excitations. At any given time at which the sectors are excited, the dormant crescent sector is a crescent sector directly opposite that crescent sector substantially homologous with nodal region 73. In some embodiments of the invention, the duty cycle of the excitation bursts is relatively high and the bursts are separated by relatively short “switching periods” during which the power supply or power supplies exciting crescent sector 31-34 are suitably switched between the different excitation configurations of the crescent sectors. Optionally, the excitation bursts are characterized by a relatively low duty cycle less than or equal to about 5%. Optionally, the duty cycle is less than or equal to about 2.5%. Optionally the duty cycle is less than or equal to about 1%. In FIGS. 2A-2B, the crescent sector of crescent sectors 31-34 which is dormant is shown shaded.

By way of illustrative example, assume that crescent sectors 31-34 are repeatedly pulsed with bursts of AC voltage at regular intervals at times t=kΔt where k is an increasing integer and Δt is a switching time interval between sequential times at which the crescent sectors are excited. The relative initial phases of the AC voltage bursts applied to crescent sectors 31-34 for the clockwise rotation of intensity pattern 70 shown in FIGS. 2A-2D are given below in Table 1.

The first column of Table 1, labeled “SECTOR”, identifies a crescent sector of cap transducer 20. Each of the other columns is labeled with the designation of a figure to which data in the column applies. For a given column labeled by a designation of a figure, the entry immediately below the figure designation gives a simulated time “t” in units of Δt which AC voltages are applied to crescent sectors of cap transducer 20. Below the time are the relative phases of the applied voltages. At any given time t, the crescent sector having phase 0 is the dormant crescent sector. It is noted that the phases of the AC bursts in a given column are a cyclic permutation of the phases of the other columns, and as a function of time, the 0° phase moves up in the columns. For a counterclockwise rotation of missing arm pinwheel intensity pattern 70, the 0° phase moves down in the columns.

TABLE 1

| | FIG. 2A | FIG. 2B | FIG. 2C | FIG. 2D |
|---|---|---|---|---|
| SECTOR | t = 0 | t = Δt | t = 2Δt | t = 3Δt |
| 31 | 90° | 180° | 270° | 0° |
| 32 | 180° | 270° | 0° | 90° |
| 33 | 270° | 0° | 90° | 180° |
| 34 | 0° | 90° | 180° | 270° |

It is noted that whereas in the above description, crescent transducers are excited with phased bursts of AC voltage, in some embodiments of the invention, excitation of crescent sector transducers is continuous, with relative phase between adjacent excited sectors equal to about 90°. A dormant sector is provided by reducing to substantially zero, amplitude of the continuous excitation of a crescent sector.

The inventor has found that a time dependent pinwheel intensity pattern, such as intensity pattern 60, having time dependence similar to that shown in FIGS. 1A-1D or a missing arm pinwheel intensity pattern such as pattern 70 that rotates in time, can be advantageous for treating biological tissue. For example, such patterns generate pressure gradients advantageous for treating tissue that are generally not evidenced by prior art intensity patterns and can provide enhanced spatial homogenization of acoustic stress in tissue. Time dependence of patterns in accordance with embodiments of the invention also provides degrees of temporal freedom additional to those generally provided by prior art for matching stress generating pressure gradients of acoustic fields to relaxation times or resonant frequencies of tissue to which they are applied.

Depending upon magnitude and/or time dependence of change in intensity patterns in accordance with embodiments of the invention, tissue stress generated by the gradients can be advantageous in providing and controlling inertial or non-inertial cavitation in the tissue. In some embodiments of the invention, the tissue stress comprises mechanical stress, and involves shearing and/or torsional stress in addition to compression and tensile stress. Optionally, for controlling cavitation, time dependence of the patterns is determined responsive to a relaxation time that characterizes decrease in a number of micro-bubbles in a tissue region that characterize cavitation in the tissue region. For example, in some embodiments of the invention, the magnitude and rate of change, e.g. a rate of change in shape or a rotation rate, of a time dependent pinwheel intensity pattern, are configured to slow the rate of decrease in the number of micro-bubbles.

(Inertial cavitation, also referred to as unstable cavitation, refers to cavitation in which a void or bubble in a material rapidly collapses, producing a shock wave and a relatively “violent” release of energy. Non-inertial cavitation, also referred to as stable cavitation, refers to cavitation in which a bubble in a material is forced to oscillate in size or shape as a result of being subject to forces generated by an input of energy, for example as may be provided by an acoustic field.)

Time dependent acoustic intensity patterns in accordance with embodiments of the invention are not limited to the pinwheel patterns 60 and 70 described above, or to pinwheel patterns, and patterns other than those described above may be used in the practice of the invention.

For example, a pinwheel intensity pattern in accordance with an embodiment of the invention may have a number of arms different from the number of arms of pinwheel intensity patterns 60 or 70. Optionally, such patterns are generated by cap transducers having a number of crescent sectors different from four. For example, a cap transducer similar to cap transducer 20 but having eight crescent sector piezoelectric elements can be used to provide a time dependent pinwheel similar to pinwheel pattern 60 shown in FIGS., 1A-1D but having eight arms instead of four. Opposite crescent sector elements of the eight element cap transducer are optionally driven by AC voltage at a same frequency, f₁ or f₂, and adjacent crescent sector elements are driven by AC voltage at a different one of frequencies f₁ or f₂. The eight crescent sector cap transducer may be used, in accordance with an embodiment of the invention, to generate a rotating missing arm pinwheel intensity pattern having seven arms by simultaneously exciting all but one of the crescent sectors with bursts of appropriately phased AC voltages of a same frequency and leaving one of the crescent sectors dormant. The missing arm intensity pattern is rotated clockwise or counterclockwise by rotating the dormant crescent sector element respectively clockwise or counterclockwise between bursts.

In some embodiments of the invention, a cap transducer comprises a relatively large number of “N” crescent sector elements having a relatively small azimuthal pitch. Optionally, the crescent sector elements are excited with AC voltage to produce a rotating pinwheel intensity pattern having “M” arms. To produce the pattern in accordance with an embodiment of the invention, M groups of crescent elements, hereinafter referred to as “excitation groups”, are repeatedly simultaneously excited with bursts of AC voltage while at least one crescent element is left dormant. Each excitation group of the M excited elements comprises a plurality of contiguous crescent sector elements that are excited with a same AC voltage. Optionally, the number of crescent sector elements in each excitation group is the same. Adjacent excitation groups are excited with substantially same frequency AC voltages and optionally having a phase difference equal to 2π/M. Optionally, the at least one dormant crescent sector element, hereinafter referred to as a “dormant group of crescent sector elements” or “dormant group”, comprises a relatively small plurality of contiguous crescent sector elements. The position of the dormant group is rotated between consecutive AC voltage bursts clockwise or counterclockwise to rotate the pinwheel intensity pattern respectively clockwise or counterclockwise.

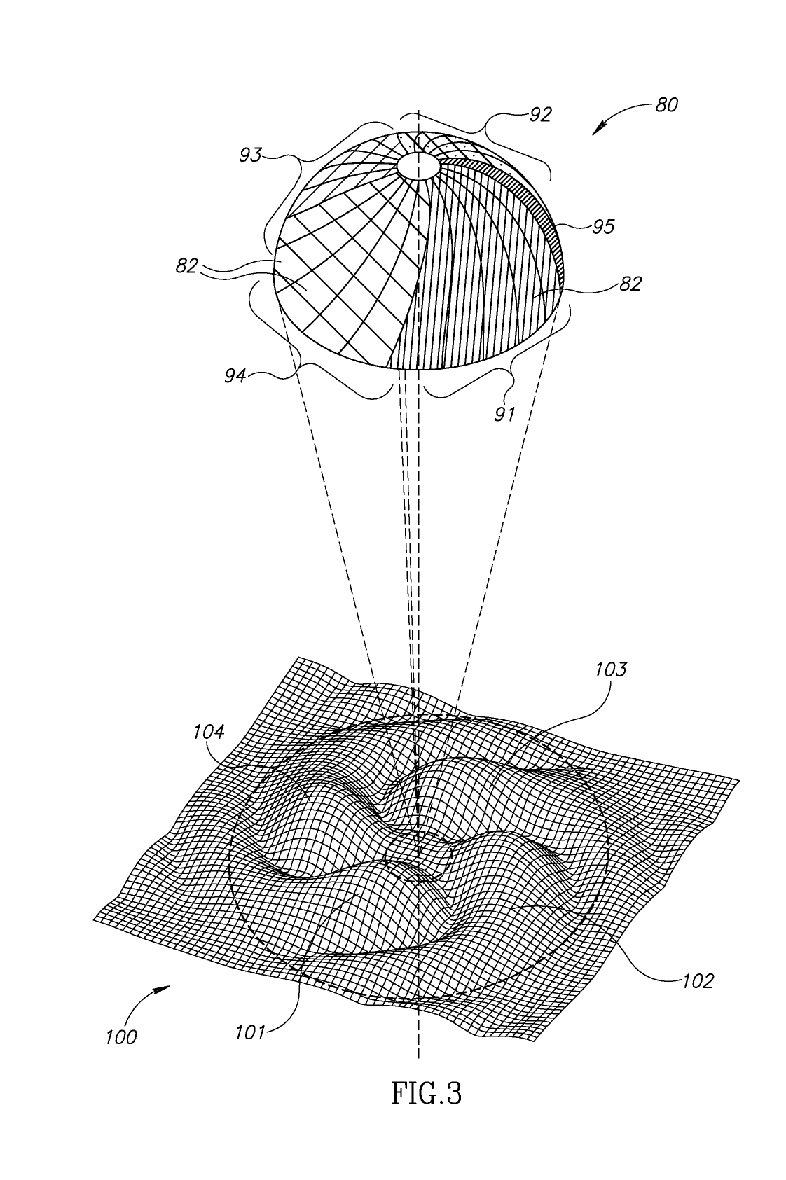

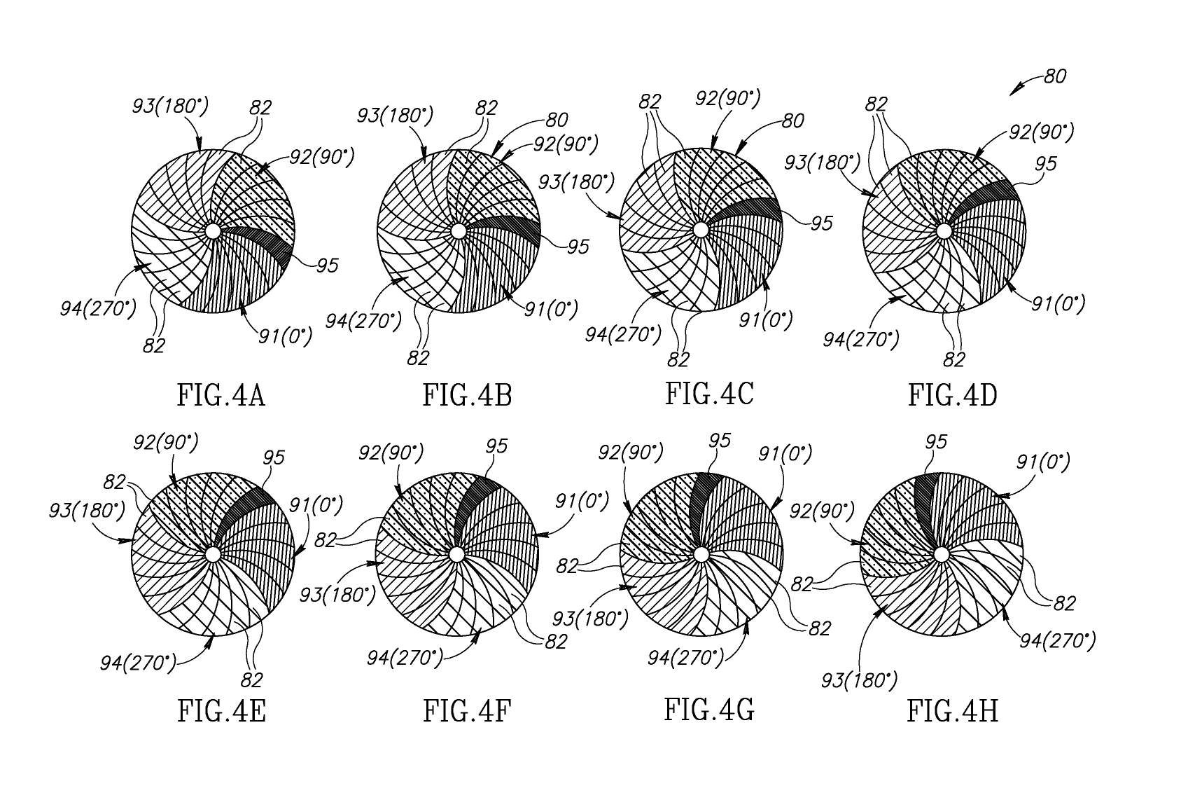

By way of example, FIG. 3 schematically shows a cap transducer 80 comprising a plurality of optionally N=21 (azimuthal pitch equal to 2π/21≈17.1°) crescent sector piezoelectric elements 82, in accordance with an embodiment of the invention. The excitation configurations are used to generate a rotating pinwheel intensity pattern 100 having M=4 arms 101-104, in accordance with an embodiment of the invention. The four arm pinwheel intensity pattern is similar to that shown in FIGS. 1A-1D and FIGS. 4A-4H show successive excitation configurations of crescent piezoelectric elements 82 used, in accordance with an embodiment of the invention, to produce and rotate the intensity pattern counterclockwise.

In accordance with an embodiment of the invention, each configuration comprises M=4 excitation groups 91, 92, 93 and 94 (also shown in FIG. 3), each group comprising five contiguous crescent sector elements 82. For convenience of presentation different excitation groups are differentiated by distinctive hatching. The excitation groups are repeatedly, simultaneously pulsed with bursts of AC voltage having a same frequency and phase difference between adjacent excitation groups equal to 90° and phase difference equal to 180° between excitation groups substantially opposite each other. A dormant group 95 in each configuration comprises, optionally, a single dormant crescent sector element 82, which is indicated by relatively dark shading. Excitation groups 91-94 and dormant group 95 are rotated counterclockwise by one crescent sector, i.e. through an angle equal to the azimuthal pitch, 17.1°, of the crescent sectors, between excitations of cap transducer 80. Therefore, in FIGS. 4A-4H, each succeeding figure shows excitation groups 91-94 and dormant crescent sector 95 rotated by the azimuthal angular pitch relative to the preceding figure. Relative phase of the AC bursts for each excitation group is indicated. FIGS. 4A-4H schematically show a sequence of successive excitation configurations that rotate a four armed pinwheel through 119.7°.

It is noted that whereas rotating acoustic intensity patterns described above are generated by cap transducers having optionally crescent sector piezoelectric elements, rotating intensity patterns can be generated, in accordance with embodiments of the invention, using transducers other than cap transducers. For example, a planar piezoelectric transducer may be used to generate rotating acoustic intensity patterns. The planar transducer optionally comprises straight or crescent sector piezoelectric elements that are excited similarly to the manner is which cap transducer 20 or 80 is excited to generate a rotating intensity pattern.

It is further noted that substantially any transducer comprising a rotationally symmetric array of piezoelectric elements can be excited to provide a rotating intensity pattern, in accordance with an embodiment of the invention, by exciting excitation groups of the elements and rotating a dormant group of elements.

Whereas in the above discussion, the relative phases of AC voltages applied to piezoelectric sector elements are controlled, the inventor has determined that asymmetric intensity patterns that provide pressure gradients advantageous for treating biological tissue may be generated relatively simply and efficiently by exciting sector elements with different AC voltage frequencies, optionally without controlling relative phase. In accordance with an embodiment of the invention, the AC voltages are characterized by relatively close frequencies.

Optionally, the frequencies are sufficiently close so that a beat frequency between any two of the frequencies in the group of frequencies is less than or equal to about 15% of the lowest frequency in the group of frequencies. Optionally, the frequencies are sufficiently close so that a beat frequency between any two of the frequencies is less than or equal to about 10% of the lowest frequency in the group of frequencies. Optionally, the frequencies are sufficiently close so that a beat frequency between any two of the frequencies in the group of frequencies is a frequency less than or equal to about 1% of the lowest frequency in the group of frequencies. In some embodiments of the invention, the frequencies differ by a frequency between about 300 Hz and about 20 kHz.

For example, the inventor has performed computer simulations for exciting a spherical cap transducer having four spherical triangle sector piezoelectric elements in which each sector is excited with a different frequency AC voltage and optionally random relative phase. In one of the simulations, the cap transducer had a radius of curvature equal to 85 mm and an aperture of 50 mm and its four sector elements were excited with AC voltage at respective frequencies 190, 200, 210 and 220 kHz. The excitation generated a highly asymmetric intensity pattern in a focal zone of the transducer that provided advantageous pressure gradients and exhibited relatively enhanced spatial homogenization due to relatively “turbulent” time dependence of the pattern.

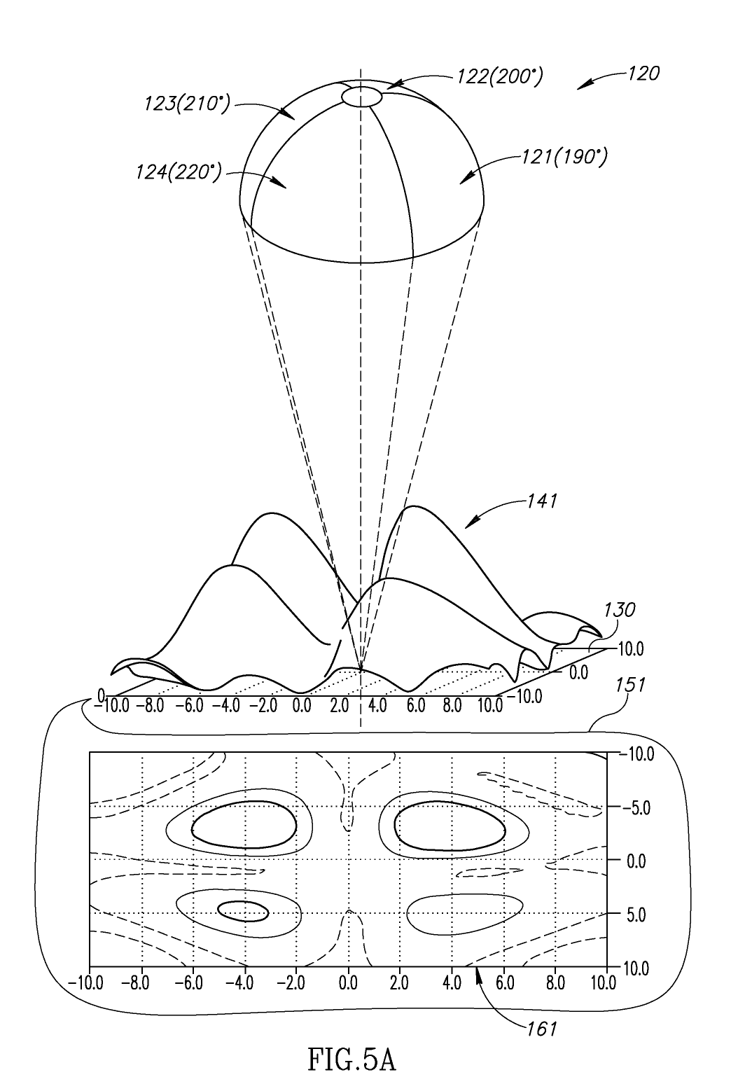

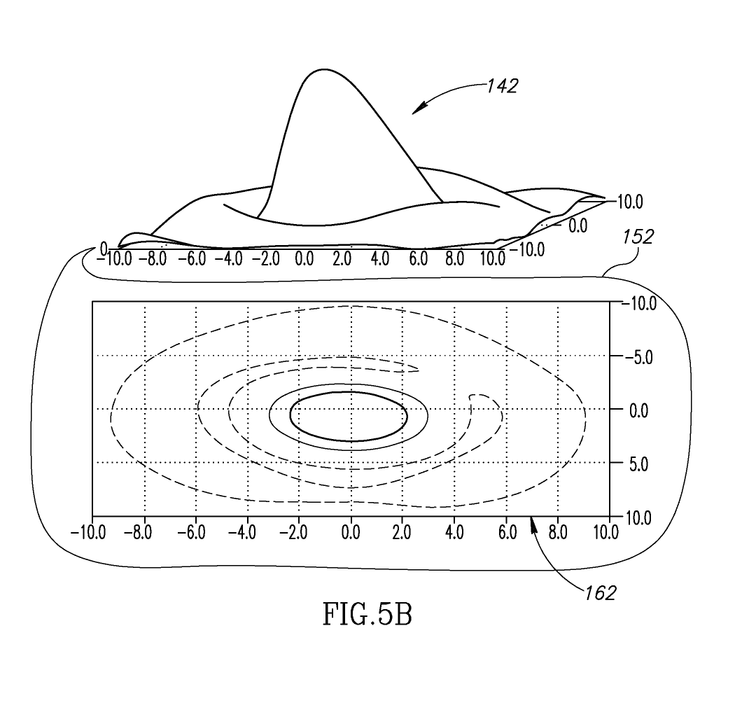

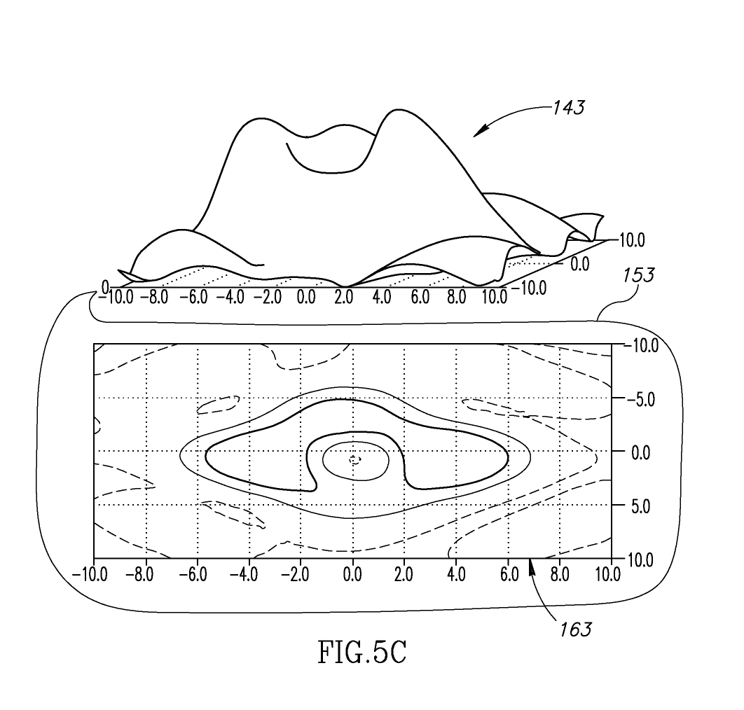

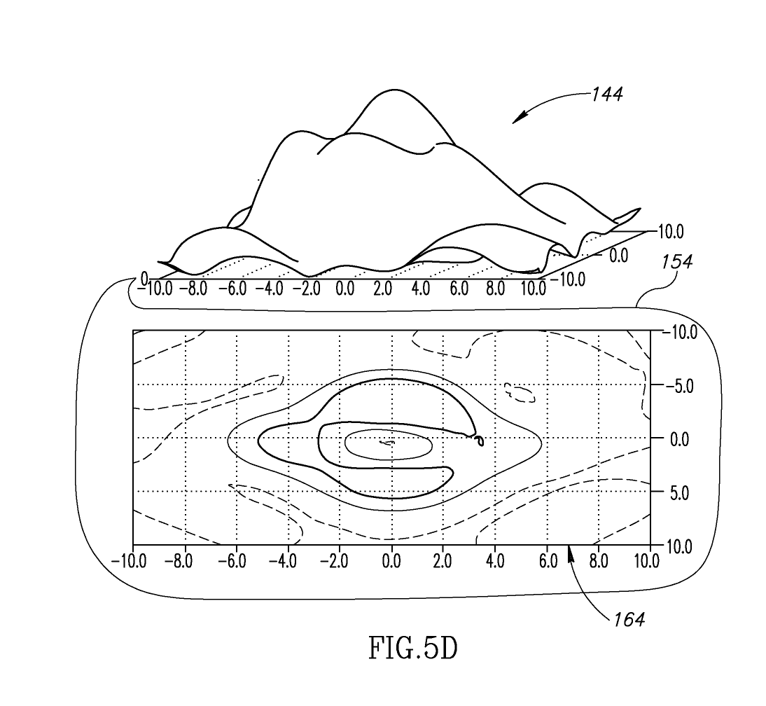

FIG. 5A shows a schematic of a spherical cap transducer 120 having four spherical triangular sector piezoelectric elements 121, 122, 123 and 124 that represents the spherical cap transducer simulated in the computer simulations. The frequency at which each element 121, 122, 123 and 124 is excited is shown in parenthesis next to the numeral identifying the element. For excitation at the given frequencies, cap transducer 120 generates a time dependent acoustic intensity pattern at a focal plane 130 of the cap transducer that has a repetition frequency and period determined by the beat frequencies of the excitation frequencies. Witness lines along orthogonal axes of focal plane 130 are labeled with distances in mm from the center of the focal plane. For the given excitation frequencies, the repetition frequency is about 10 kHz. In general, for a plurality of different frequencies a repetition frequency of the frequencies is substantially equal to a largest common denominator of differences between the frequencies.

FIG. 5A schematically shows a schematic perspective image 141 of the acoustic intensity pattern generated by simulated cap transducer 120 at focal plane 130 of the transducer for the noted excitation frequencies at a time to of a repetition cycle. An inset 151 in the figure shows a contour map 161 of the intensity pattern. Contour lines in the contour map are distinguished by different line styles and contour lines having a same line style are isobars characterized by same acoustic intensity. Dashed contour lines represent a relatively low pressure, a thin solid contour line an intermediate pressure and a bold solid contour line a relatively high pressure. FIGS. 5B, 5C and 5D schematically show perspective images 142, 143 and 144 and corresponding contour maps 162, 163 and 164 respectively of the intensity pattern at subsequent times t₁, t₂ and t₃ during the repetition cycle. Times t₁, t₂ and t₃ follow time to at times 0.2T, 0.3T and 0.5T, where T represents the period of the repetition cycle. Images 141, 142, 143 and 144 and associated contour maps 161, 162, 163 and 164 show that the time dependent acoustic pattern provided by cap transducer 120, in accordance with an embodiment of the invention, is characterized by substantial intensity in a focal area about 15 mm square and exhibits substantial change and spatial irregularity during a repetition cycle.

In the description and claims of the present application, each of the verbs, “comprise” “include” and “have”, and conjugates thereof, are used to indicate that the object or objects of the verb are not necessarily an exhaustive listing of members, components, elements or parts of the subject or subjects of the verb.

The invention has been described with reference to embodiments thereof that are provided by way of example and are not intended to limit the scope of the invention. The described embodiments comprise different features, not all of which are required in all embodiments of the invention. Some embodiments of the invention utilize only some of the features or possible combinations of the features. Variations of embodiments of the described invention and embodiments of the invention comprising different combinations of features than those noted in the described embodiments will occur to persons of the art. The scope of the invention is limited only by the following claims.

1. A transducer for generating an intensity pattern of ultrasound comprising:
a plurality of elements independently excitable to radiate acoustic energy; and
a controller that simultaneously excites some of the elements while leaving at least one element dormant and changes which element is dormant to change the intensity pattern.

2. A transducer according to claim 1 wherein the configuration of elements is rotationally symmetric.

3. A transducer according to claim 1 wherein the location of at least one dormant element is rotated selectively clockwise or counterclockwise as a function of time.

4. A transducer according to claim 1 wherein the at least one dormant element comprises a single element.

5. A transducer according to claim 1 wherein the at least one dormant element comprises a group of adjacent elements.

6. A transducer according to claim 1 wherein some of the elements comprise at least two groups of elements, each group comprising a plurality of adjacent elements.

7. A transducer according to claim 1 wherein the controller excites at least two elements with AC voltages at different frequencies.

8. A transducer according to claim 7 wherein the controller excites the elements with bursts of AC voltage.

9. A transducer according to claim 7 wherein the frequencies are relatively close.

10. A transducer according to claim 9 wherein a beat frequency between any two of the frequencies is less than or equal to about 15% of a lowest frequency of the frequencies.

10. A transducer according to claim 9 wherein a beat frequency between any two of the frequencies is less than or equal to about 10% of a lowest frequency of the frequencies.

11. A transducer according to claim 9 wherein a beat frequency between any two of the frequencies is less than or equal to about 1% of a lowest frequency of the frequencies.

12. A transducer according to claim 9 wherein a beat frequency between any two of the frequencies is in a range between about 300 Hz and about 20 kHz.

13. A transducer according to claim 1 wherein the controller excites at least two different elements with a same frequency AC voltage having different phases.

14. A transducer according to claim 1 wherein the controller rotates the location of the at least one dormant element clockwise or counterclockwise as a function of time.

15. A transducer according to claim 1 wherein the intensity pattern exhibits a shape of a pinwheel having a plurality of arms.

16. A transducer according to claim 15 wherein the pinwheel pattern is missing an arm.

17. A transducer according to claim 1 and having a shape of a spherical cap.

18. A transducer according to claim 17 wherein the elements are sectors of the cap having a shape of a spherical triangle.

19. A transducer according to claim 17 wherein the elements are sectors of the cap having a crescent shape.

20. A transducer for generating an intensity pattern of ultrasound comprising:
a plurality of elements independently excitable to radiate acoustic energy; and
a controller that simultaneously excites at least three different elements at different frequencies wherein a beat frequency between any two of the frequencies is in a range between about 300 Hz and about 20 kHz.

21. A transducer for generating an intensity pattern of ultrasound comprising a plurality of crescent shaped elements independently excitable to radiate acoustic energy.
